(19) United States
(12) Patent Application Publication
(10) Pub. No.: US 2007/0120643 A1
(43) Pub. Date: May 31, 2007

(54) Portable storage device with wireless identification function

(76) Inventor: Jiunn-Chung Lee, Taipei (TW)

Correspondence Address: HDSL, 4331 STEVENS BATTLE LANE, FAIRFAX, VA, 22033, US

(21) Appl. No.: 11/530,137

(22) Filed: Sep. 8, 2006

(30) Foreign Application Priority Data
Nov. 25, 2005 (TW) 094143546

(51) Int. Cl. G05B 19/00

(52) U.S. Cl. 340/5.61; 340/5.74; 340/572.1

(57) ABSTRACT

A radio frequency identification (RFID) used for the security function of a portable storage device includes a radio frequency transceiver and an electronic tag. The radio frequency transceiver is installed in the portable storage device, such that if a user wants to read data in the portable storage device through a computer system, the radio frequency transceiver will transmit an interrogation signal to search for an electronic tag within a signal receivable range. After the electronic tag receives the interrogation signal, it will transmit a response signal to the transceiver for performing an authentication to confirm whether or not the user has the right of reading the data in the portable storage device.

### BACKGROUND OF THE INVENTION

1. Field of the Invention

The present invention relates to a portable storage device, and more particularly to a portable storage device having a security function.

2. Description of Prior Art

In recent years, computers play an important role in our life, particularly various different hardware and software used in our working environments of information operation, computerized word processing, presentation and spreadsheet become indispensable to business enterprises. In the present that emphasizes convenience, portable information products including notebook computers, flash disks and the like have become an efficient tool to individuals' work. However, the convenience of these portable products also comes with a risk of being stolen or taken away. Once if a portable product is lost or stolen, its related information or important data will be misappropriated or used, which will cause tremendous loss to business enterprises or individuals, so that such portable tools have a major issue on information security.

Particularly for flash disks, the flash disks feature a large capacity, and an easy-to-carry and plug-and-play advantage, so that many users gradually substitute floppy disks with flash disks for storing and carrying data. However, the volume of flash disks is very small and thus the flash disks may be lost or even stolen easily. Therefore, finding a way of protecting the security of data in a flash disk demands immediate attentions and feasible solutions.

In general, users usually set up a password to work together with computer software and flash disks to protect their data. In the method of entering a password to achieve the effect of protecting data, it is necessary to install a password program to a related computer that reads the flash disk, or else the flash disk cannot be used. Although the password adds a certain level of security to the data protection, the password method requires related software for encrypting or reading data and setting up the password and reading the flash disk, which will weaken the advantages of the flash disks and cause inconvenience to users. Further, the password can be cracked by those who are familiar with the password technology or the users may forget the password, and all these create much trouble to users.

In the past, many high-end notebook computer systems come with a design of a fingerprint identification system, so that the unique fingerprint of every user provides a better security to computers. The principle of the built-in fingerprint identification system in a computer system mainly installs a fingerprint identification chip in the computer, so that intruders cannot access the data in the computer, and such design can extend its application to the flash disks. A prior art has disclosed a flash dish structure having a fingerprint identification system, wherein a user builds the user's unique fingerprint in an identification chip of the flash disk, such that when the user wants to read the flash disk, the user simply uses his/her own fingerprint to achieve the effect of protecting the security of data without using a password or its related software.

Although the built-in fingerprint identification function of the flash disk can protect the data of the flash disk and prevent the data from being cracked by unauthorized people after the flash disk is lost or stolen, such fingerprint identification system may be unable to identify the fingerprint due to a possible damage caused by the electrostatic charges of the user's body. Furthermore, a fingerprint sensing panel may become insensitive or useless after it gets dirty or worn out after a long time of use, and thus the function of protecting data in the flash disk cannot be used anymore. The area of a fingerprint sensing surface is restricted by the chip fabrication process and its yield rate. If we want to improve the yield rate or get a larger sensing surface, the cost of the built-in chip will be increased. Although the foregoing method for protecting data is feasible, the structure, cost, and application of the method still have the foregoing shortcomings, and thus such method still require further improvements.

### SUMMARY OF THE INVENTION

In view of the foregoing shortcomings of the prior art, the inventor of the present invention based on years of experience in the related industry to conduct experiments and modifications, and finally designed a portable disk storage device with a wireless identification function in accordance with the present invention.

Therefore, the present invention is to overcome the foregoing shortcomings and avoid existing deficiencies by providing a portable disk storage device with a wireless identification function, wherein the radio frequency transceiver in the portable storage device is coupled with the electronic tag by a wireless signal for confirming the user's right of reading data, so as to achieve the data protection function.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a schematic view of a structure of the present invention;

FIG. 2 is a flow chart of the operation of the present invention;

FIG. 3 is a schematic view of operations of a first preferred embodiment of the present invention;

FIG. 4 is a schematic view of operations of a second preferred embodiment of the present invention; and

FIG. 5 is a schematic view of operations of a third preferred embodiment of the present invention.

### DETAILED DESCRIPTION OF THE INVENTION

The technical characteristics, features and advantages of the present invention will become apparent in the following detailed description of the preferred embodiments with reference to the accompanying drawings. However, the drawings are provided for reference and illustration only and are not intended for limiting the scope of the invention.

The present invention adopts a radio frequency identification (RFID) technology to a portable storage device, and the main structure of the RFID includes a radio frequency (RF) transceiver and an electronic transceiver and an electronic tag, wherein the electronic tag is a passive component containing an antenna, a receiver, a transmitter and a memory unit, and the transceiver transmits a signal with a specific frequency to an electronic tag within a receivable range through radio waves, and the antenna of the electronic tag receives and sends the signal to the receiver. After a circuit in the electronic tag produces an induced current for the signal, the memory unit will send a response signal to the radio frequency transceiver through the transmitter, and then the transceiver will carry out the identification.

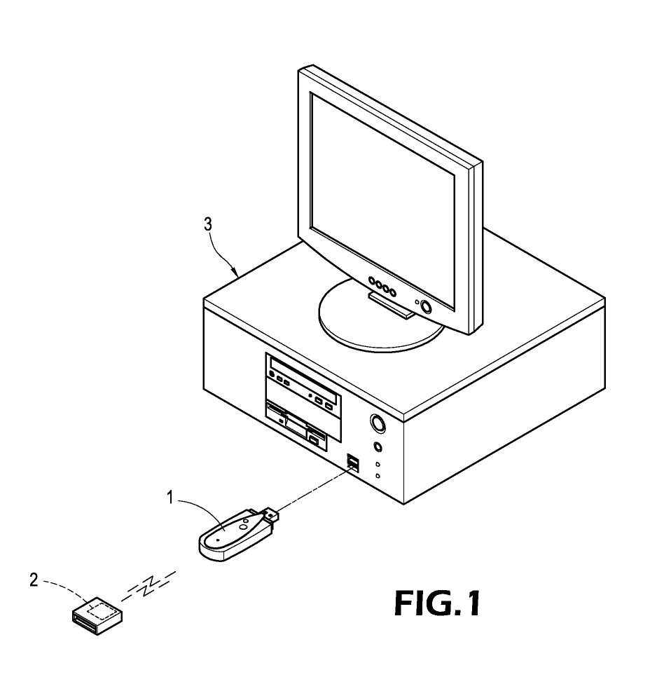

Referring to FIG. 1 for a schematic view of a structure of the present invention, a portable storage device 1, which is a flash disk, includes a radio frequency (RF) transceiver disposed therein and electrically coupled to the portable storage device 1 through a control module (which will be described below) and an electronic tag 2 disposed within a receivable range of the transceiver. The electronic tag 2 can be installed on a fixed object such as a computer system or the electronic tag 2 can be installed on a portable object such as a flash disk casing or a card, so that the portable storage device 1 can connect the radio frequency transceiver and its electronic tag 2 through wireless signals to provide a wireless identification function. The portable storage device 1 is connected to a computer system 3 through a universal serial bus (USB) interface.

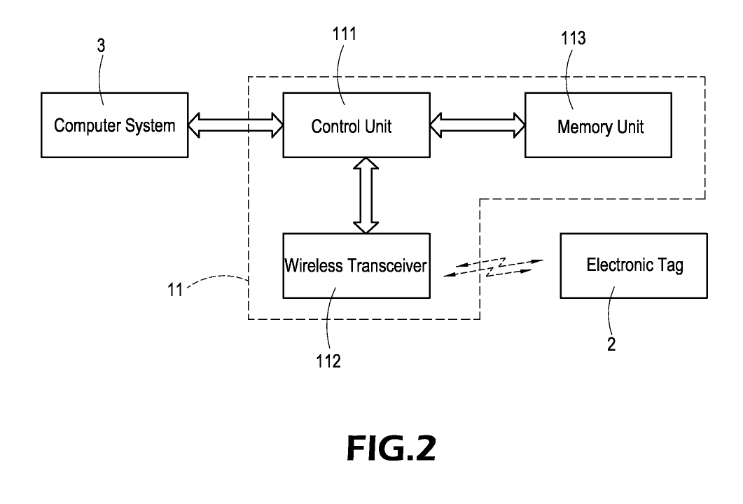

Referring to FIG. 2 for a flow chart of the operation of the present invention, a portable storage device with a wireless identification function 1 is connected to a computer system 3 by a universal serial bus (USB) interface, so that the computer system 3 can detect the existence of the portable storage device 1, and the portable storage device 1 is electrically coupled to a control module 11. The control module 11 includes a control unit 111, a radio frequency transceiver 112 and a memory unit 113. The control unit 111 is electrically coupled to the radio frequency transceiver 112 and the memory unit 113. When the computer system 3 tries to read the memory unit 113 in the portable storage device 1, the read signal of the computer system 3 will enable the control unit 111, and the control unit 111 will transmit an interrogation signal from a radio frequency channel through the radio frequency transceiver 112 to search for an electronic tag 2 within a receivable range of the interrogation signal. After the electronic tag 2 receives its interrogation signal, the electronic tag 2 will send a response signal to the radio frequency transceiver 112 to carry out the identification. If the response signal of the electronic tag 2 is correct, then the control unit 111 will respond to the computer system 3 and agree to read the memory unit 113 of the portable storage device 1. On the contrary, if the response signal of the electronic tag 2 is incorrect or the radio frequency transceiver 112 has received no response signal of the electronic tag 2, then the control unit 111 will respond to the computer system 3, such that the control unit 11 will not read the memory unit 113 of the portable storage device 1. Further, the control unit 111 will continue transmitting the interrogation signal to the electronic tag 2 through the radio frequency transceiver 112 within a predetermined time. Once if the electronic tag 2 cannot respond, the control unit 111 will interrupt the reading process of the computer system 3 immediately.

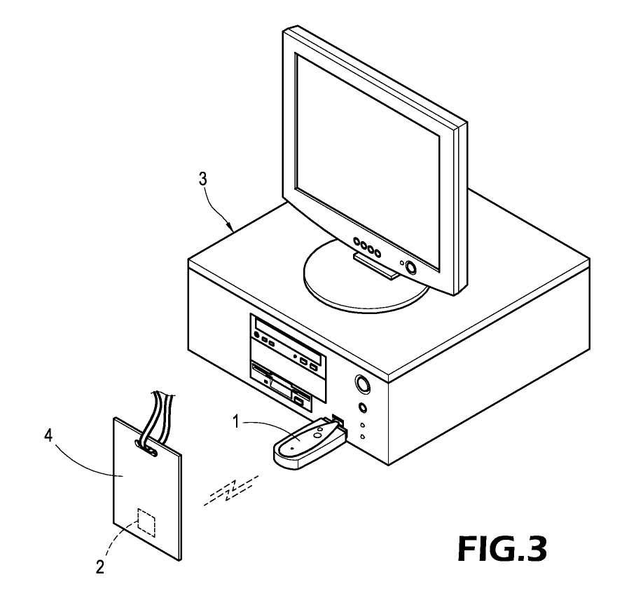

Referring to FIG. 3 for a first preferred embodiment of the present invention, a portable storage device with a wireless identification function 1 is connected to a computer system 3 through a USB interface, and the electronic tag 2 is installed on a card 4 such as an employee identification card. If a user wants to read the portable storage device 1 through a computer system 3, a control module 11 electrically coupled to the portable storage device 1 transmits an interrogation signal to an electronic tag 2 within a receivable range through the radio frequency transceiver 112, and the electronic tag 2 will transmit a response signal to the radio frequency transceiver 112. After the radio frequency transceiver 112 identifies the response signal, the user is permitted to read the data of the portable storage device 1. On the contrary, if the signal responded by the electronic tag 2 does not match or the card 4 is not within the receivable range, then the user will not be able to read the portable storage device 1.

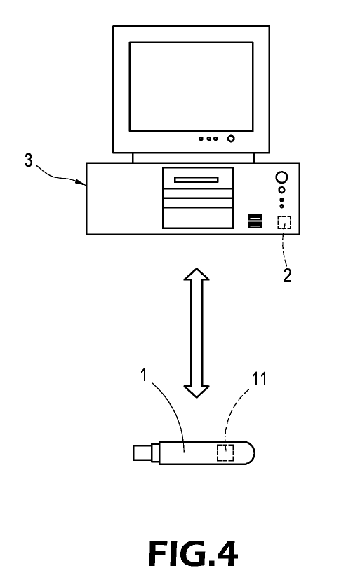

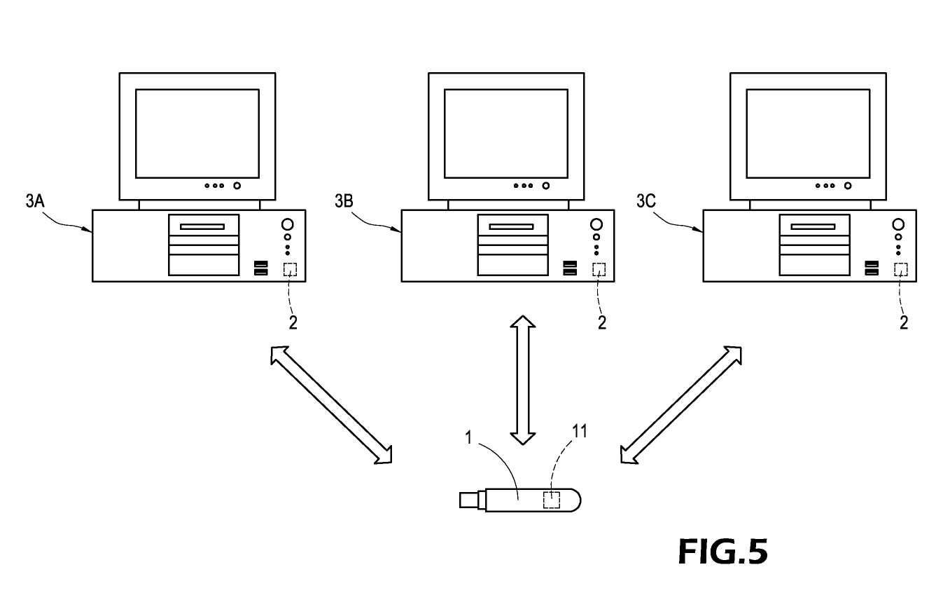

Referring to FIG. 4 for a second preferred embodiment of the present invention, the electronic tag 2 can be fixed onto a computer system 3, such that if a user connects the portable storage device with a wireless identification function 1 to the computer system 3, the computer system 3 will detect the existence of the portable storage device 1. In the meantime, the control module 11 installed in the portable storage device 1 will send an interrogation signal to an electronic tag 2 of the computer system 3 through the transceiver 112, and the electronic tag 2 will transmit a response signal to the radio frequency transceiver 112. After the transceiver 112 identifies the response signal, it will confirm whether or not the user has the right of reading the portable storage device 1. The foregoing one-to-one identification method can be extended to for the application of one-to-many identification. In a computer system 3 existing in the same environment or possessing the right of reading the computer system 3 as shown in FIG. 5 or a plurality of computer systems 3A, 3B, 3C having the same identification for the electronic tag 2, the control module 11 installed in the portable storage device 1 will transmit an interrogation signal through the transceiver 112 to confirm the existence of the electronic tag 2, and the electronic tag 2 will transmit a response signal to the transceiver 112 to carry out the identification, so as to confirm whether or not a user of any one of the computer systems 3A, 3B, 3C has the right of reading the portable storage device 1, if the user wants to use the portable storage device with a wireless identification function 1,

The present invention is illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A portable storage device with a wireless identification function, comprising:
a control module, having a radio frequency transceiver, such that if a user operates the portable storage device 1, the transceiver will transmit an interrogation signal through a radio frequency channel and will transmit the same interrogation signal within a predetermined time interval; and
an electronic tag, for receiving the interrogation signal from the radio frequency transceiver and then transmitting a response signal to the radio frequency transceiver for carrying out an identification.

2. The portable storage device with a wireless identification function of claim 1, wherein the electronic tag is a passive component.

3. The portable storage device with a wireless identification function of claim 1, wherein the electronic tag is installed onto a portable object.

4. The portable storage device with a wireless identification function of claim 1, wherein the electronic tag is installed onto a protective cover of the portable storage device.

5. The portable storage device with a wireless identification function of claim 1, wherein the electronic tag is installed onto a card.

6. The portable storage device with a wireless identification function of claim 1, wherein the electronic tag is installed onto a fixed object.

7. The portable storage device with a wireless identification function of claim 1, wherein the electronic tag is installed onto a computer system.

8. The portable storage device with a wireless identification function of claim 1, wherein the radio frequency transceiver and the electronic tag adopt a RFID technology.

9. The portable storage device with a wireless identification function of claim 1, wherein the radio frequency transceiver and the electronic tag are one-to-one identification.

10. The portable storage device with a wireless identification function of claim 1, wherein the radio frequency transceiver 112 and the electronic tag are one-to-many identification.
